(19) United States
(12) Patent Application Publication
(10) Pub. No.: US 2004/0139353 A1
(43) Pub. Date: Jul. 15, 2004

(54) Methodology and system for real time information system application intrusion detection

(76) Inventor: Jonathan Brett Forcade, Lake in The Hills, IL (US)

Correspondence Address: Jonathan Brett Forcade, 19969 Presidents Cup Ter, Ashburn, VA, 20147, US

(21) Appl. No.: 10/714,999

(22) Filed: Nov. 17, 2003

Related U.S. Application Data
(60) Provisional application No. 60/427,401, filed on Nov. 19, 2002.

(51) Int. Cl. H04L 9/00

(52) U.S. Cl. 713/201

(57) ABSTRACT

A methodology and system for application intrusion detection wherein the methodology constructs an application profile database that compares user requests to computer applications to determine their security threat. The methodology, Application Profiling, defines the characteristics of user interactions that are to be catalogued in the application profile database. In addition, the methodology identifies the process for creating the application profile database and defines the logic used to evaluate user application requests for anomalous behavior. The methodology also provides a format for communication of application security threats. The system implements the methodology in a stand-alone fashion.

### FIELD OF THE INVENTION

The invention pertains to a methodology and system for analyzing, cataloguing and processing application user requests providing information security application intrusion detection in real time for a variety of uses.

### BACKGROUND OF THE INVENTION

Networks are increasing in their complexity and size. Once focused solely on voice, data streams now drive them. Cobbled together by a maze of copper and fiber segments joined together through masses of high-speed silicon, networks continue to be implemented to assist in structuring traffic flow based purely on a permit or deny evaluation process. The problem networks face is in discerning the patterns of normal and anomalous traffic. This problem has intensified with the drive to e-business. Present technology operates by controlling (allowing or denying) traffic that meets specific criteria. Existing intrusion detection systems (q.v. 6405318, Rowland, June 2002) focus on network or host based signature or anomaly recognition of security threats. Application level intrusion detection for security threats is overlooked.

### BRIEF SUMMARY OF THE INVENTION

The Application Profiling methodology collects and summarizes application traffic patterns and then correlates whether user access is violating application access policies, and then reports these results enabling enhanced security management decisions.

In essence, an operational map is derived of the application access policy based on the logical connections allowed for each application. This map is like a unique fingerprint. As such it provides a verifiable reference model that enables irregularities to be identified, recorded and reported. The Application Profiling methodology derives the reference model through actual patterns of use, supporting application policies that are used to identify anomalies such as security threats or changes in use patterns.

The scope of the Application Profiling methodology is vast. The days of isolated networks with no interaction to the outside world are over. When application infrastructures existed only to support internal users, a suitable application policy could be developed within the boundaries of a two-dimensional allow/deny perspective. The coordination of today's complex information infrastructure requires a multi-dimensional approach, with the key element being non-invasive, precise and repeatable information sampling that can be correlated and composed into actionable recommendations. The Application Profiling methodology provides the crucial mechanism to do just that. The Application Profiling methodology assesses application traffic flow, to enable informed decisions about application access policies and anomalies providing insight into what is happening to applications based on real network traffic.

The Application Profiling system implements the Application Profiling methodology to provide application level intrusion detection for awareness of security threats to computer applications.

### BRIEF DESCRIPTION OF THE DRAWINGS

FIG. 1 is an entity relationship diagram illustrating how the Characteristics defined herein for Application Profiling relate to the Computer Application.

FIG. 2 is a flow chart of the overall Application Profiling Methodology.

FIG. 3 is a flow chart of the unidentified user subprocess.

FIG. 4 is a flow chart of the unidentified user command subprocess.

FIG. 5 is a flow chart of the invalid user parameter subprocess.

### DESCRIPTION OF EMBODIMENTS OF THE INVENTION

This methodology would be implemented in conjunction with existing network or host based Intrusion detection systems (q.v. 6405318, Rowland, June 2002) or implemented in the system described below in a stand-alone fashion for application specific intrusion detection.

PATENT SPECIFICATION

Every computer application has deterministic characteristics for handling user requests for data. This methodology identifies three critical characteristics that can be observed unobtrusively through normal user interaction. While the characteristics are being observed, they can be catalogued based on this profiling methodology to create a basis for comparison of subsequent user requests to determine if the requests are suspect.

An example of the deterministic nature of computer applications is as follows. A Human Resources Administrator uses a computer application to record merit increase in employee salaries. In order to record the merit increase, the Administrator would be presented the following view of the merit entry screen after logging into a computer terminal in his office:

Employee ID:______

New Salary:______

Effective Date:______

Press Enter to commit, Escape to cancel, and Tab to change fields

The administrator would enter three parameters to the application in order to affect a merit increase. When the application was developed, the computer programmer defined characteristics about the type of information that would be entered by the Administrator and the corresponding responses. In this example, the application is expecting a 5 digit number for the Employee ID, up to a 6 digit number for New Salary representing adjusted annual pay, and a 6 digit number representing the Effective Date in a MMDDYY format. After the information is entered, the application then processes the merit increased based on the information entered by the Administrator and responds accordingly.

In production code, the computer program checks the information that entered to ensure data validity. If the Administrator were to enter the employee's name instead of his or her 5-digit employee ID, then the application is designed to catch the erroneous data and reject the input. If the application programmer failed to anticipate this incorrect input and the erroneous data is accepted, the overall application would be affected by corrupt data.

Since applications must have a clearly defined input and response strategy for accepting user data submissions and requests, the Application Profiling methodology proposed illustrates critical characteristics of users requests that can be profiled to observe for potentially malicious activity.

Three of these user request characteristics that can be profiled for potentially anomalous behavior are:

User Identification

User Command

User Parameters

A User Command (UC) is an action sent to an application. In the example above, the Enter key triggered the UC. The Employee ID, New Salary and Effective Data are User Parameters (UP) are then processed by the application. Since the request is sent via the computer terminal that the Administrator used to login with, the application is able to establish User Identification (UI) for the request.

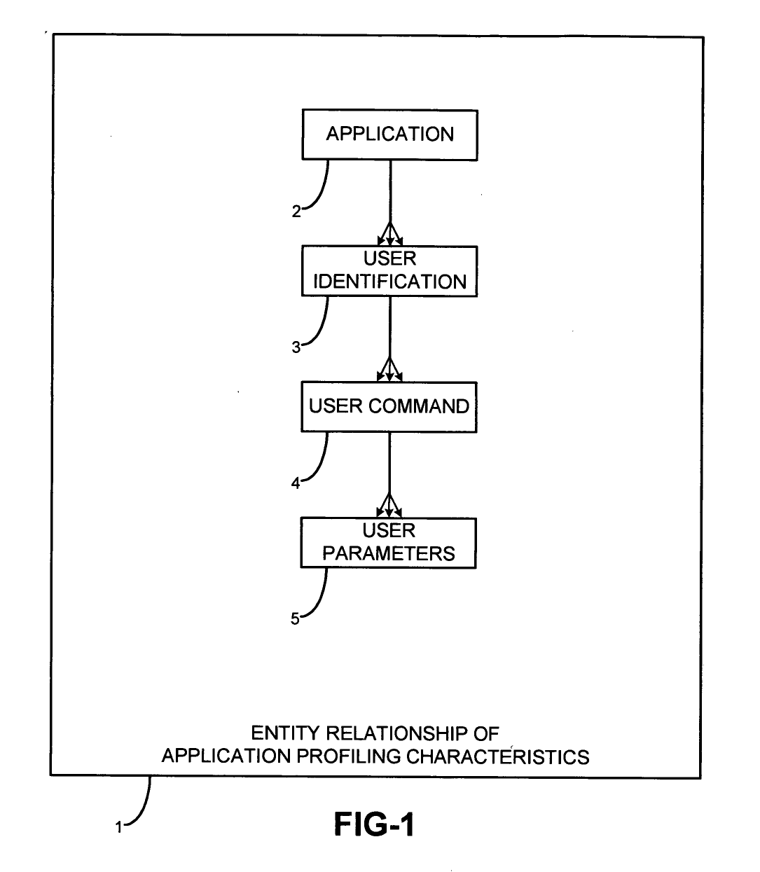

This methodology constructs a catalogue of relationships between UI's, UC's and UP's. The catalogue represents the deterministic profile the computer programmer intended for users to access the application. This catalogue is referred to as the Application Profile database in further discussions and is illustrated in FIG. 1 (1).

In the Application Profile database, an application (2) has a one to many relationship with UI's (3). The UI's (3) have a one to many relationship to UC's (4). UC's have a one to many relationship to UP's (5). In FIG. 1 the lines with multiple arrows on the end illustrate a one to many relationship.

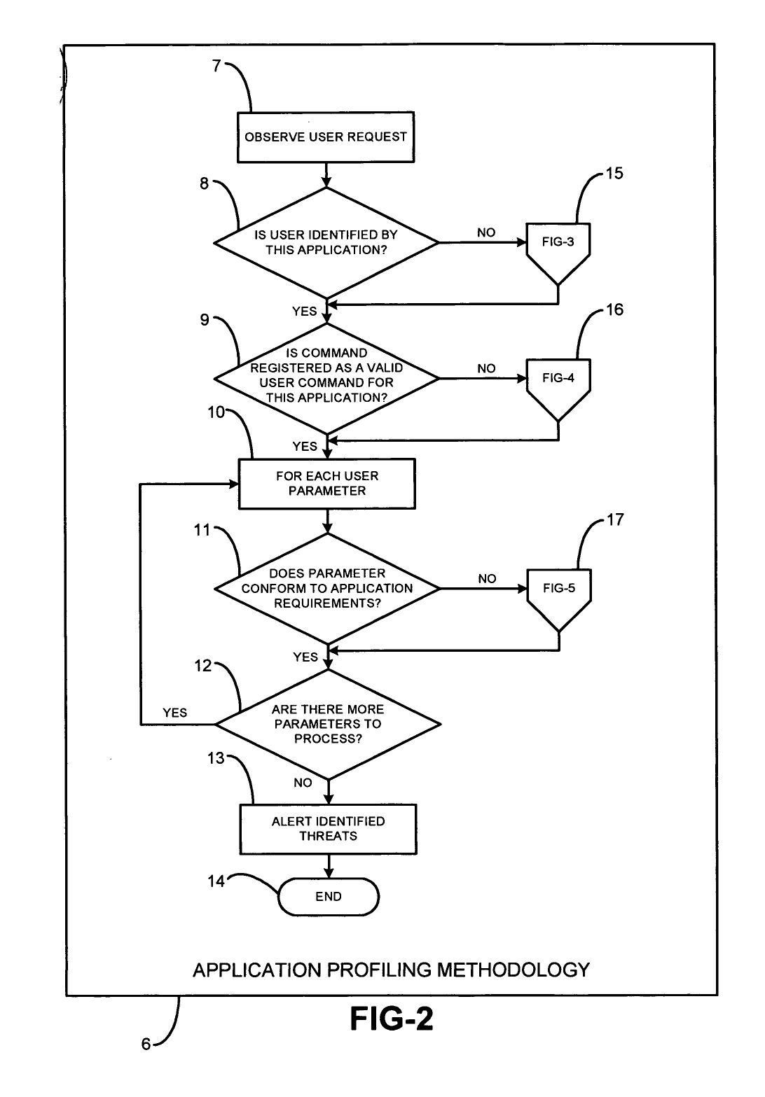

When a user attempts to access an application FIG. 2, the Application Profile database is referenced to see if that user has a relationship with the application (8). If not, then a subprocess is called to handle the registration of the user (15). The command executed by the user is then compared (9) to determine if it is valid for this application. If not, then a subprocess is called to handle the registration of the command (16). Although different applications can share the same commands, the Application Profile database maintains separate entity mappings for each application. Each parameter that is supplied by the user (10) is then compared (11) to determine if it meets the learned parameter requirements for the application. If not, then a subprocess is called to handle the registration of the parameter (17). A comparison is made (12) to determine if more parameters are required. Then identified security threats are alerted (13).

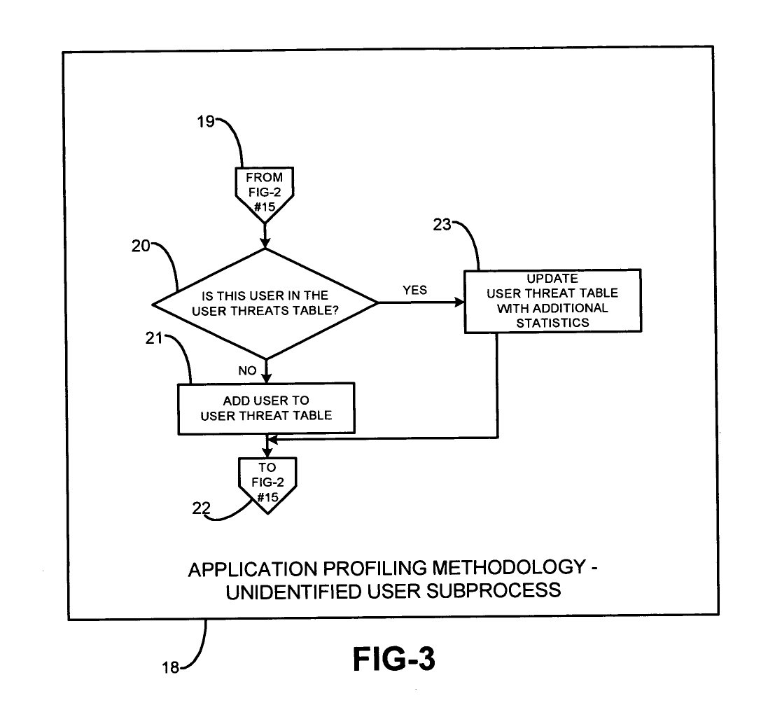

The invalid user subprocess (18), FIG. 3, begins (19) by comparing whether the user is already registered as a threat (20). If yes, then the user's existing record is updated with additional statistics (23). If no, then the user is added to the user threat table (21). Then the subprocess returns (22) back to its invocation point (15).

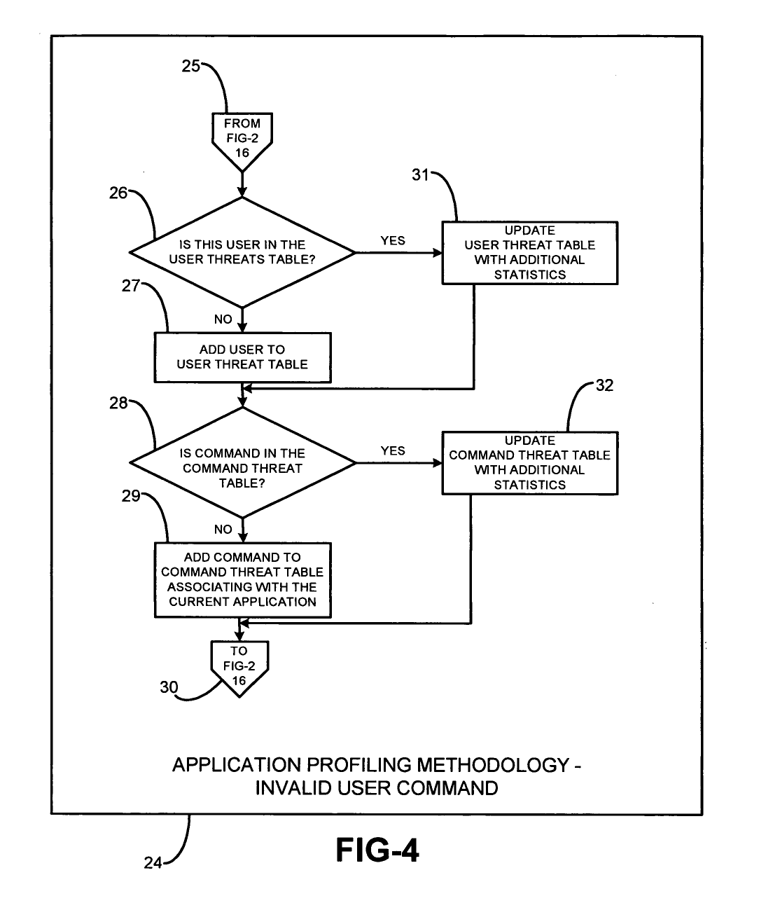

The invalid command subprocess (24), FIG. 4, begins (25) by comparing whether the user is already registered as a threat (26). If yes, then the user's existing record is updated with additional statistics (31). If no, then the user is added to the user threat table (27). Next, the subprocess compares whether the command is registered in the command threat table (28). If yes, then the command's existing record is updated with additional statistics (32). If no, then the command is added to the command threat table (29) with an association to the existing application. Then the subprocess returns (30) back to its invocation point (16).

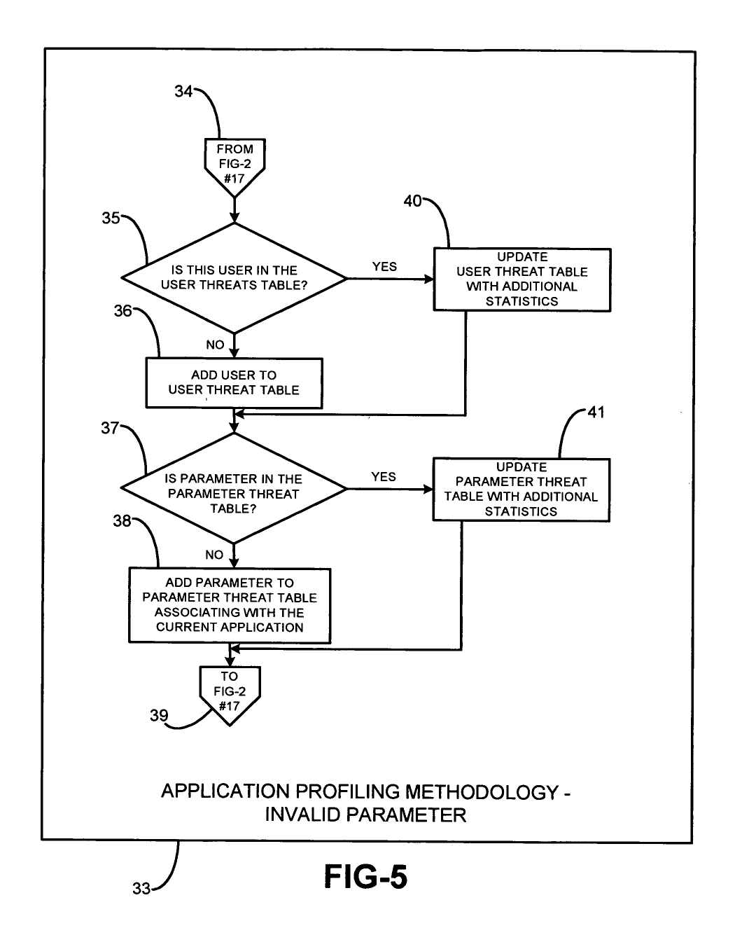

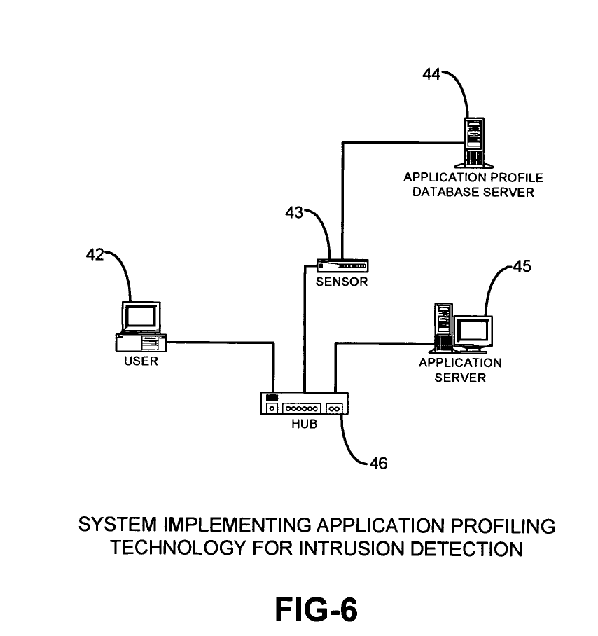

The invalid parameter subprocess (33), FIG. 5, begins (34) by comparing whether the user is already registered as a threat (35). If yes, then the user's existing record is updated with additional statistics (40). If no, then the user is added to the user threat table (36). Next, the subprocess compares whether the parameter is registered in the parameter threat table (37). If yes, then the parameter's existing record is updated with additional statistics (41). If no, then the parameter is added to the parameter threat table (38) with an association to the existing application. Then the subprocess returns (39) back to its invocation point (17).

This methodology supports ongoing administrative modification to the catalogue to support application changes deployed by the computer programmer or to expand the permissible limits of the user. In FIG. 2, during verifying UI (8), UC (9), and UP (11) a lookup is performed against the Application Profile database. For existing entries, a flag is set to determine whether the comparison is valid, not valid or ignored. Newly identified items are placed into the Application Profile database with a default value of not valid.

This methodology can be implemented as a system in a stand alone fashion for dedicated application intrusion detection. The system, FIG. 6, can monitor application interactions between the user (42) and the application (45) via a sensor (43) that is connected to a hub (46). The sensor extracts information requests made by the user and sends this information to the Application Profile database server (44) for analysis, cataloguing and processing of user requests. The Application Profile database server maintains the unique profiles for each application that the sensor is directed to monitor. In addition, the Application Profile database server performs alerting of security threats even though this function could be done in a separate component dedicated to this function.

What is claimed:

1. An anomaly based methodology for information system application intrusion detection, the method comprising the steps of:
a. non-intrusive monitoring of user requests.
b. cataloguing of user requests to an application into an application profile database.
c. analysis including comparison of user requests to the application profile database to identify potential security threats.
d. format for reporting identified security threats.

2. A system for Information System application intrusion detection via three components to the system, comprising the following elements:
a. a sensor focused on extracting the characteristic elements of application users requests as defined by the Application Profiling methodology.
b. an Application Profile database that performs the cataloguing and analysis of user requests.
c. a reporter that communicates identified security threats.
